(19) United States
(12) Patent Application Publication
(10) Pub. No.: US 2025/0384652 A1
(43) Pub. Date: Dec. 18, 2025

(54) GROUNDED PROMPTING AND ADAPTATION FOR REFERRING VIDEO OBJECT SEGMENTATION

(71) Applicant: NVIDIA Corporation, Santa Clara, CA (US)

(72) Inventors: Min-Hung Chen, Zhubei City (TW); Ci-Siang Lin, Taipei City (TW); Chien-Yi Wang, New Taipei City (TW); Sifei Liu, San Diego, CA (US); Yu-Chiang Wang, Taipei City (TW)

(21) Appl. No.: 19/072,880

(22) Filed: Mar. 6, 2025

Related U.S. Application Data
(60) Provisional application No. 63/660,963, filed on Jun. 17, 2024.

(51) Int. Cl. G06V 10/26; G06T 7/70; G06V 10/25; G06V 10/40; G06V 10/774; G06V 10/776; G06V 10/82; G06V 20/40

(52) U.S. Cl. CPC G06V 10/26; G06T 7/70; G06V 10/25; G06V 10/40; G06V 10/774; G06V 10/776; G06V 20/46; G06T 2207/10016; G06T 2207/20081; G06T 2207/20084; G06T 2207/20104; G06V 10/82; G06V 2201/07

(57) ABSTRACT

Referring Video Object Segmentation (RVOS) aims to segment an object referred to by a sentence query throughout an entire video. In contrast to Referring Image Segmentation (RIS), RVOS is particularly faced with dynamic visual challenges, such as position and size variation, pose deformation, object occlusion or exit, and scene variation. Moreover, the referring sentence may contain long-term motions or actions, which may not be easily recognized from a single frame. Existing works that address this challenging task generally require end-to-end training for vision-language models, which can be computationally expensive and time-consuming, while the requirement of dense mask annotations for training impedes the scalability of those approaches. The present disclosure uses grounded prompting to adapt image-based segmentation models to video object segmentation tasks, which can be achieved with relying only on weak supervision.

### CLAIM OF PRIORITY

This application claims the benefit of U.S. Provisional Application No. 63/660,963 (Attorney Docket No. NVIDP1408+/24-TP-0750US01) titled “EFFICIENT GROUNDED PROMPTING AND ADAPTATION FOR REFERRING VIDEO OBJECT SEGMENTATION,” filed Jun. 17, 2024, the entire contents of which is incorporated herein by reference.

### TECHNICAL FIELD

The present disclosure relates to the computer vision task of referring object segmentation.

### BACKGROUND

Referring Video Object Segmentation (RVOS) aims to segment an object referred to by a sentence query throughout an entire video. In contrast to Referring Image Segmentation (RIS), RVOS is particularly faced with dynamic visual challenges, such as position and size variation, pose deformation, object occlusion or exit, and scene variation. Moreover, the referring sentence may contain long-term motions or actions (e.g., “a gold fish on the left swimming towards the top right”), which may not be easily recognized from a single frame.

To address this challenging task, many works have been proposed. However, most existing methods require end-to-end training for vision-language models, which can be computationally expensive and time-consuming. Moreover, the requirement of dense mask annotations for training impedes the scalability of those approaches. Recently, use of foundation segmentation models has been proposed, but there are still challenges in the RVOS problem not addressed by those foundation models, such as not being tailored to handle natural language descriptions and video data in RVOS.

There is a need for addressing these issues and/or other issues associated with the prior art. For example, there is a need to use grounded prompting to adapt image-based segmentation models to video object segmentation tasks.

### SUMMARY

A method, computer readable medium, and system are disclosed for training a model to generate location information for a target object in a video based on a text prompt referring to the target object in the video. A training video is accessed in a dataset of training videos each labeled with a text prompt referring to an object in the training video and per-frame bounding boxes corresponding to the object in the training video. The model is trained to generate frame-level bounding boxes for the object referred to by the text prompt labeled in the training video. The model is trained to provide a video-level alignment of the frame-level bounding boxes with the text prompt labeled in the training video.

### BRIEF DESCRIPTION OF THE DRAWINGS

FIG. 1 illustrates a flowchart of a method for training a model to generate location information for a target object in a video based on a text prompt referring to the target object in the video, in accordance with an embodiment.

FIG. 2 illustrates a system for referring video object segmentation, in accordance with an embodiment.

FIG. 3A illustrates a system framework for training the location generation model of FIG. 2 to generate frame-level bounding boxes for a referred object in a video, in accordance with an embodiment.

FIG. 3B illustrates a system framework for training the location generation model of FIG. 2 to provide video-level alignment of frame-level bounding boxes with a text prompt, in accordance with an embodiment.

FIG. 4 illustrates a flowchart of a method for using referring video object segmentation for a downstream application, in accordance with an embodiment.

FIG. 5A illustrates inference and/or training logic, according to at least one embodiment;

FIG. 5B illustrates inference and/or training logic, according to at least one embodiment;

FIG. 6 illustrates training and deployment of a neural network, according to at least one embodiment;

FIG. 7 illustrates an example data center system, according to at least one embodiment.

### DETAILED DESCRIPTION

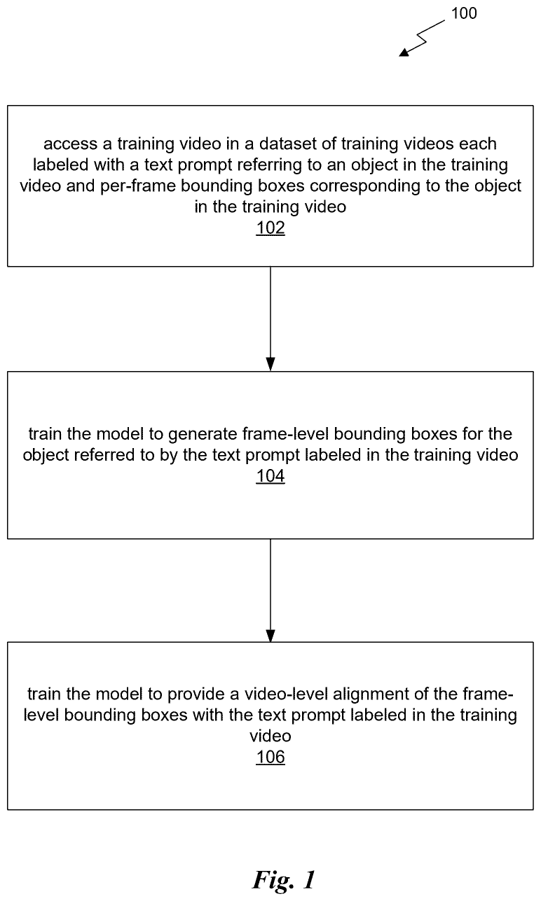

FIG. 1 illustrates a flowchart of a method 100 for training a model to generate location information for a target object in a video based on a text prompt referring to the target object in the video, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

As mentioned above, the method 100 is performed for training a model to generate location information for a target object in a video based on a text prompt referring to the target object in the video. The method 100 may be repeated over multiple iterations to train the model. Each iteration may be performed using different training data, as described herein.

In operation 102, a training video is accessed in a dataset of training videos each labeled with a text prompt referring to an object in the training video and per-frame bounding boxes corresponding to the object in the training video. The training video is accessed from the dataset, or accessed from a memory storing the dataset, for the purpose of using the training video to train the model, as described below.

In an embodiment, the training video includes at least one video frame (also referred to herein as simply a “frame”). In an embodiment, the training video includes a sequence of video frames. The training video may capture a scene from a single viewpoint or from a plurality of different viewpoints (e.g. via a moving camera).

As mentioned, the training video is labeled with a text prompt referring to an object in the training video. The object is any particular (also referred to herein as “target”) physical object depicted in the training video. The object may be stationary or moving in the scene. The text prompt includes any text, such as a word or a phase or a complete sentence, which refers to the object in the training video. The text prompt may name the object, name a category of the object, describe a visual appearance of the object, and/or describe a movement of the object in the scene. In an embodiment, the text prompt may be labeled to the entire video or every frame of the video.

As also mentioned, the training video is labeled with per-frame bounding boxes corresponding to the object in the training video. In other words, each of one or more frames of the video, or each of all frames of the video, is labeled with a bounding box representing coordinates of the object in the frame. In an embodiment, the bounding box may define both the location and size of the object in the frame.

In operation 104, the model is trained to generate frame-level bounding boxes for the object referred to by the text prompt labeled in the training video. In an embodiment, supervised training may be used to train the model to generate the frame-level bounding boxes for the object referred to by the text prompt labeled in the training video. In an embodiment, the training of operation 104 may include iteratively: using the model to generate from the training video a set of frame-level bounding boxes for the object referred to by the text prompt labeled in the training video, computing a loss between the set of frame-level bounding boxes and the per-frame bounding boxes labeled in the training video, and updating the model based on the loss.

In an embodiment, using the model to generate from the training video the set of frame-level bounding boxes for the object referred to by the text prompt labeled in the training video may include: extracting frame-level visual features for each frame of the training video and linguistic features of the text prompt labeled in the training video, obtaining a set of object queries using the frame-level visual features of each frame of the training video and the linguistic features of the text prompt labeled in the training video, using the set of object queries to generate the frame-level bounding boxes for the object referred to by the text prompt labeled in the training video, computing a loss between the frame-level bounding boxes and the per-frame bounding boxes labeled in the training video, and updating the model based on the loss.

In an embodiment, each object query in the set of object queries may correspond to a frame of the training video and may include the visual features of the frame as a key and the linguistic features of the text prompt labeled in the training video as a value. In an embodiment, each object query in the set of object queries may correspond to a frame of the training video and may be used to generate a plurality of candidate bounding boxes in the frame for the object referred to by the text prompt labeled in the training video. With respect to this embodiment, one of the candidate bounding boxes having a highest confidence score from among the plurality of candidate bounding boxes may be selected as the frame-level bounding box for the frame.

In an embodiment, contrastive learning may be used to train the model to generate the frame-level bounding boxes for the object referred to by the text prompt labeled in the training video. In an embodiment, the contrastive learning may be performed using a different set of frame-level bounding boxes generated by the model for a different object referred to by a different text prompt. For example, the model may be trained to generate frame-level bounding boxes that are more like the labeled bounding boxes and less like the different set of frame-level bounding boxes associated with the different object.

In operation 106, the model is trained to provide a video-level alignment of the frame-level bounding boxes with the text prompt labeled in the training video. The video-level alignment refers to aligning the text prompt with the objected referred to by the text prompt at the video level. In an embodiment, the training of operation 106 may include extracting video-level visual features for the training video, and using the video-level visual features to train the model to provide the video-level alignment of the frame-level bounding boxes with the text prompt labeled in the training video. The video-level visual features refer to any visual features corresponding to the video (e.g. multiple frames of the video).

In an embodiment, the video-level visual features for the training video may be extracted by: extracting frame-level visual features for each frame of the training video, performing cross-attention at each frame of the training video by taking the frame-level bounding box for the frame as a query and the frame-level visual features for the frame as keys and values, and applying an average pooling operation for temporal aggregation of a result of the performance of the cross-attention at each frame of the training video to generate the video-level visual features for the training video.

In an embodiment, contrastive learning may be used train the model to provide the video-level alignment of the frame-level bounding boxes with the text prompt labeled in the training video. In an embodiment, the contrastive learning may be performed using linguistic features of the text prompt labeled in the training video and linguistic features of a different text prompt referring to a different object in the training video. For example, the model may be trained to align the frame-level bounding boxes to correspond more to the text prompt referring to the object and to correspond less to the different text prompt referring to the different object in the training video.

The result of the video-level alignment is location information for the object in the training video. To this end, the model, once trained via the method 100, can be executed to generate location information for a target object in a given input video based on an input text prompt referring to the target object in the video. The location information may then be used for referring video object segmentation. In an embodiment, the location information for the target object may be configured to be provided as a prompt to an image-based foundation segmentation model to provide referring video object segmentation for the input video.

In an embodiment, the method 100 may further include deploying the trained model. In an embodiment, the trained model may be deployed with an image-based foundation segmentation model to adapt the image-based foundation segmentation model to provide referring video object segmentation. In an embodiment, at inference time: the trained model may generate location information for the target object in the video based on the text prompt referring to the target object in the video, and the trained model may then input the location information, the video, and the text prompt to the image-based foundation segmentation model to cause the image-based foundation segmentation model to generate object masks for the target object in the video. The object masks may refer to per-frame masks that correspond to the target object, or in other words that represent the object in each frame of the video.

In an embodiment, the object masks generated by the image-based foundation segmentation model may be used by a downstream application. For example, the downstream application may be a video editing application. In this example, an instruction to edit the object in the video may cause the video editing application to edit the object in each frame of the video as represented by the object masks generated for the object by the image-based foundation segmentation model. As another example, the downstream application may be a video analysis application. In this example, the object may be tracked in the video using the object masks generated for the object by the image-based foundation segmentation model, for example to collect data on the object and to analyze the same for generating alerts, reports, etc.

Further embodiments will now be provided in the description of the subsequent figures. It should be noted that the embodiments disclosed herein with reference to the method 100 of FIG. 1 may apply to and/or be used in combination with any of the embodiments of the remaining figures below.

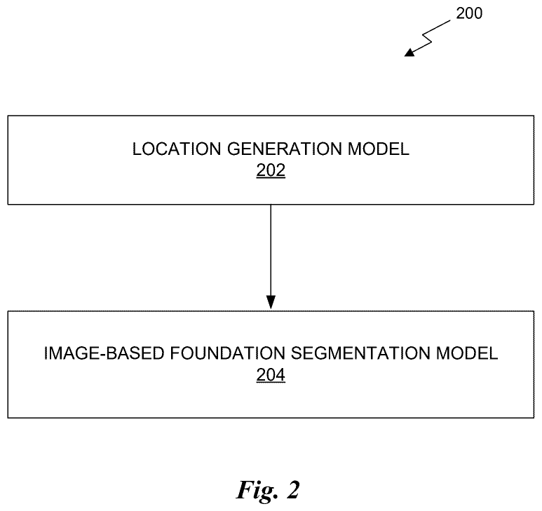

FIG. 2 illustrates a system 200 for referring video object segmentation, in accordance with an embodiment. The system 200 may be implemented in hardware, software, or a combination thereof. Components of the system 200 may be implemented on a single computing device or across multiple computing devices which may be locally connected or connected via a network.

As shown, the system 200 includes a location generation model 202. The location generation model 202 refers to a model trained to generate location information for a target object in a given input video based on an input text prompt referring to the target object in the video. The location generation model 202 may be trained in accordance with the method 100 of FIG. 1.

The system 200 also includes an image-based foundation segmentation model 204. The image-based foundation segmentation model 204 is a pretrained model that is configured to use the location information generated by the location generation model 202 to in turn generate object masks for the video. Thus, an output of the location generation model 202 is provided as an input to the image-based foundation segmentation model 204. In an embodiment, the output of the image-based foundation segmentation model 204, or in other words, the object masks, may be provided to a downstream application (not shown) for use in performing one or more downstream tasks associated with the video (e.g. video editing, video analysis, etc.).

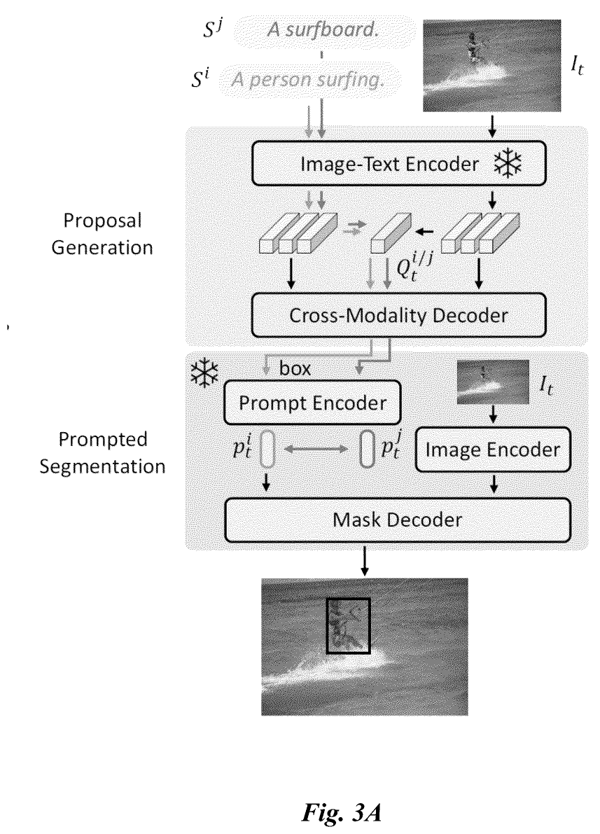

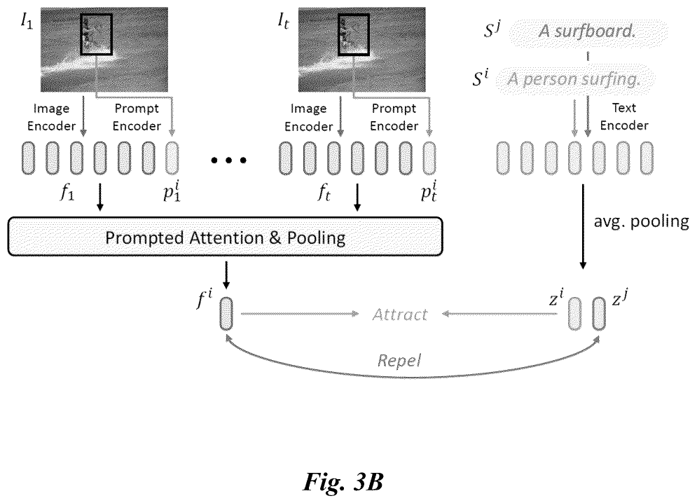

The embodiments of FIGS. 3A-B below describe frameworks for training the location generation model 202 for use with the image-based foundation segmentation model 204.

In referring video object segmentation, the training data contains a set of N videos, where each video V={Iₜ}ₜ₌₁^{T} is a sequence of T frames and is associated with a set of referring sentences S={Sᵢ}ᵢ₌₁^{M} describing M distinct objects. The goal of referring video object segmentation is to produce segmentation masks for the referred objects.

In the embodiments described herein, the training data includes box-level annotations \hat{B}ⁱ={\hat{B}ₜⁱ}ₜ₌₁^{T} for the T frames corresponding to the ith referring sentence Sᵢ, where each bounding box \hat{B}ₜⁱ is represented by the coordinate of the center point and the height and width.

Under this setting, the goal is to efficiently adapt image-based foundation segmentation models for addressing referring video object segmentation from weak supervision. To achieve efficient model adaptation, a Grounded Prompting (GroPrompt) framework is introduced, which advances vision-language learning to produce temporal-consistent yet text-aware position prompts for segmentation purposes. As shown in FIGS. 3A-B, the GroPrompt framework is designed to generate the bounding box proposal by taking object queries to perform cross-modal attention at each frame. Such proposals then serve as position prompts to instruct foundation segmentation models to segment the referred object. To facilitate the position prompts to be text- and temporal-aware, Text-Aware Prompt Contrastive Learning (TAP-CL) is provided which includes: 1) Text-Contrastive Prompt Learning (TextCon) at the frame level, which encourages the output proposals to be distinct when taking different referring sentences as input; and 2) Modality-Contrastive Prompt Learning (ModalCon), which aims to align the output proposal sequence and its corresponding object with the input text for each video clip. With the proposed TAP-CL, the GroPrompt framework will produce temporal-consistent yet text-aware position prompts for the referred object, enabling efficient adaptation from weak supervision without additional finetuning for foundation models.

Recent foundation segmentation models have presented overwhelming performance on various segmentation tasks. When prompted by points or bounding boxes indicating the positions, these foundation models would produce high-quality object masks as desired. However, existing foundation segmentation models are mainly trained from general image data and therefore have limited ability to comprehend video content or complex text descriptions. To adapt image-based foundation segmentation models to address referring video object segmentation, the GroPrompt framework is designed to learn and generate position prompts for the target object from the input video frames and the referring sentences. In this way, the GroPrompt framework enables efficient model adaptation without additional finetuning for foundation models, avoiding possible overfitting issues while reducing computational cost and time.

FIG. 3A in particular illustrates a system framework for training the location generation model 202 of FIG. 2 to generate frame-level bounding boxes for a referred object in a video, in accordance with an embodiment.

To produce precise position prompts for segmentation, vision-language learning is advanced to generate bounding box proposals for the referred object. As illustrated in FIG. 3A, the GroPrompt framework first employs a Transformer-based image-text encoder to extract visual features and linguistic features for each frame Iₜ and the referring sentence Sᵢ, respectively. A query generation mechanism is used to obtain a set of object queries

$${Q}_{t}^{i} .$$

By taking visual features and linguistic features as keys and values, the derived object queries

$${Q}_{t}^{i}$$

would perform cross-attention through the cross-modality decoder to generate the box proposal Bₜⁱ. With the ground-truth bounding box

$${\hat{B}}_{t}^{i} ,$$

the standard box loss L_{box} is formulated by the regression loss and generalized IoU loss L_{g}, per Equation 1.

$${L}_{b o x} = {𝔼}_{V , {S}^{i}} [ {\sum }_{i = 1}^{T} {λ}_{r} {‖ {B}_{t}^{i} - {\hat{B}}_{t}^{i} ‖}_{1} + {λ}_{g} {L}_{g} ( {B}_{t}^{i} , {\hat{B}}_{t}^{i} ) ] \qquad Equation 1$$

where λᵣ and λ_{g} are hyper-parameters for the two loss terms, respectively. Here, since there is typically only one target object in referring segmentation tasks, the output proposal Bₜⁱ with the highest confidence score is selected at each frame (e.g. instead of using the Hungarian loss for matching). It is worth noting that there is no need to mask loss for training like most existing referring video object segmentation works.

In referring segmentation tasks, the sentence descriptions could be ambiguous. For example, the sentence “A person surfing” in FIG. 3A refers to the person alone rather than both the person and the surfboard. To mitigate such text ambiguity in natural language, Text-Contrastive Prompt Learning (TextCon) is used at the frame level to generate distinct proposals for different referring sentences.

Formally, in addition to the input sentence Sᵢ, another sentence Sⱼ is forwarded through the GoPrompt framework to obtain the output proposal

$${B}_{t}^{j}$$

for another object at each frame. To perform contrastive learning, the prompt encoder from the foundation segmentation models is leveraged to extract the prompt embeddings

$${p}_{t}^{i} , {p}_{t}^{j} , and {\hat{p}}_{t}^{i}$$

for the proposals

$${B}_{t}^{i} and {B}_{t}^{j}$$

and the ground-truth bounding box

$${\hat{B}}_{t}^{i} ,$$

respectively. By taking

$${p}_{t}^{i} , {\hat{p}}_{t}^{i} , and {p}_{t}^{j}$$

as the anchor, positive, and negative sample, the frame-level triplet contrastive loss

$${L}_{contra}^{f}$$

is computed per Equation 2.

$${L}_{contra}^{f} = {𝔼}_{V , {S}^{i} , {S}^{j}} [ {\sum }_{i = 1}^{T} max ( 0 , {d}_{t}^{p} - {d}_{t}^{n} ) ] , where \qquad Equation 2$$

$${d}_{t}^{p} = {‖ {p}_{t}^{i} - {\hat{p}}_{t}^{i} ‖}_{2} and {d}_{t}^{n} = {‖ {p}_{t}^{i} - {p}_{t}^{j} ‖}_{2}$$

We note that to preserve the latent space learned by foundation models for segmentation, the prompt encoder is frozen during training. Under the guidance of the prompt encoder, the proposed TextCon enforces the distinctness of the proposals while enhancing the position prompts to be text-aware.

Apart from the text ambiguity, the sentence descriptions in referring video object segmentation often contain long-term motions or actions. Sentences like “a gold fish on the left swimming towards the top right” require considering all the frames as a whole to perform video segmentation.

To address this, the system framework of FIG. 3B is provided for training the location generation model 202 of FIG. 2 to provide video-level alignment of frame-level bounding boxes with a text prompt, in accordance with an embodiment. In particular, to align the text with the referred object at the video level, Modality-Contrastive Prompt Learning (ModalCon) is used.

In addition to the prompt embedding

$${p}_{t}^{i}$$

derived in Text-Contrastive Prompt Learning, the image encoder is also used to extract the visual features fₜ. With the cross-attention performed at each frame by taking the prompt embedding

$${p}_{t}^{i}$$

as the query and visual features fₜ as keys and values, followed by an average pooling layer for temporal aggregation, the video-level content feature fᵢ would be encoded for the referred object. As for the referring sentences Sᵢ and Sⱼ, the sentence-level linguistic features zᵢ and zⱼ are derived from the text encoder. Then, the video-level triplet contrastive loss

$${L}_{contra}^{v}$$

would be computed per Equation 3.

$${L}_{contra}^{v} = {𝔼}_{V , {S}^{i} , {S}^{j}} [ max ( 0 , {d}^{p} , {d}^{n} ) ] , \qquad Equation 3$$

$$where {d}^{p} = {‖ {f}^{i} - {z}^{i} ‖}_{2} and {d}^{n} = {‖ {f}^{i} - {z}^{j} ‖}_{2}$$

Note that the prompt, image, and text encoders are all frozen during training to preserve their pretrained semantic spaces while avoiding overfitting.

Finally, the total loss function Lₜₒₜₐₗ is defined per Equation 4.

$${L}_{total} = {L}_{b o x} + {L}_{contra} \qquad Equation 4$$

where

$${L}_{contra} = {λ}_{f} {L}_{contra}^{f} + {λ}_{v} {L}_{contra}^{v} ,$$

and λ_{f} and λᵥ are hyper-parameters for the two contrastive loss, respectively. With the proposed TAP-CL, the GroPrompt framework would produce temporal-consistent yet text-aware bounding box proposals, allowing video segmentation by taking the learned proposals to prompt image-based foundation segmentation models. It is worth noting that the above learning scheme does not require any dense mask annotations. Furthermore, the proposed GroPrompt framework learns to prompt instead of finetuning foundation models, enabling efficient adaptation to referring video object segmentation from weak supervision.

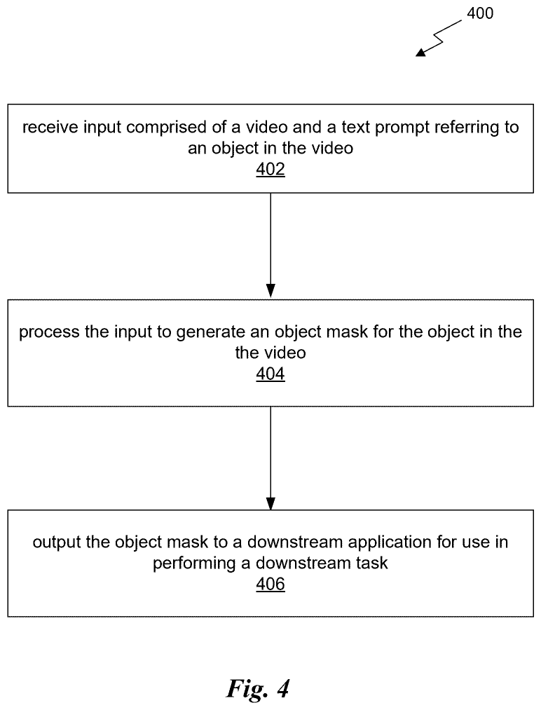

FIG. 4 illustrates a flowchart of a method 400 for using referring video object segmentation for a downstream application, in accordance with an embodiment. The method 400 may be carried out using the system 200 of FIG. 2, in an embodiment.

In operation 402, an input is received which is comprised of a video and a text prompt referring to an object in the video. The input may be received from a user via a graphical user interface (GUI). In operation 404, the input is processed to generate an object mask for the object in the video. In particular, the object mask is generated per-frame of the video. The processing operation 404 may be performed using the system 200 of FIG. 2, in an embodiment.

In operation 406, the object mask is output to a downstream application for use in performing a downstream task. In an embodiment, the downstream task may include editing the object in the video. In another embodiment, the downstream task may include analyzing the object in the video to generate a notification or a report.

### Exemplary Use Case—Video Editing

In an embodiment, the method 400 may be performed with respect to a video editing application. In this exemplary embodiment, (1) an input is received that is comprised of a video and a text prompt referring to an object in the video that is to be edited; (2) at least one frame of the video and the text prompt are processed, using a first model, to generate location information for the target object in the video, where the first model is trained to: generate a frame-level bounding box in the at least one frame of the video for the object referred to by the text prompt, and provide a video-level alignment of the frame-level bounding box with the text prompt to generate the location information for the target object in the video; (3) the location information, the at least one frame of the video, and the text prompt are processed, by a second model, to generate an object mask for the target object in the at least one frame of the video; (4) an instruction for editing the object in the video is determined; and (5) based on the instruction, a portion of the at least one frame of the video corresponding to the object mask is edited.

In an embodiment, the first model is the location generation model 202 of FIG. 2. In an embodiment, the location information may be a proposed frame-level bounding box resulting from the video-level alignment. In an embodiment, the second model is the image-based foundation segmentation model 204 of FIG. 2.

In an embodiment, the editing may be performed by a video editing application configured to use the object mask generated for the at least one frame of the video. In an embodiment, the instruction for editing the object in the video is determined from the text prompt. For example, the text prompt may include the instruction to edit the object along with a reference to the object.

In an embodiment, for each frame of the at least one frame of the video, or for each frame of a plurality of frames of the video, the editing may be performed on the portion of the frame corresponding to the object mask generated for the frame. In an embodiment, the instruction for editing the object may include an instruction to change at least one feature of the object. For example, the at least one feature of the object may include a color of the object and/or a size of the object.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

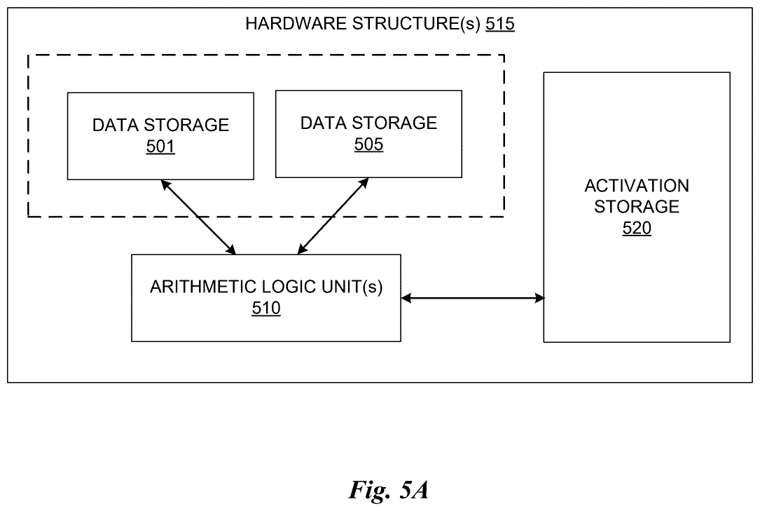

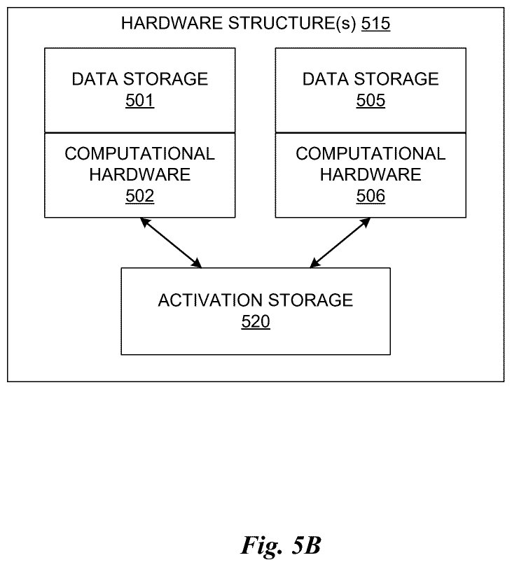

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

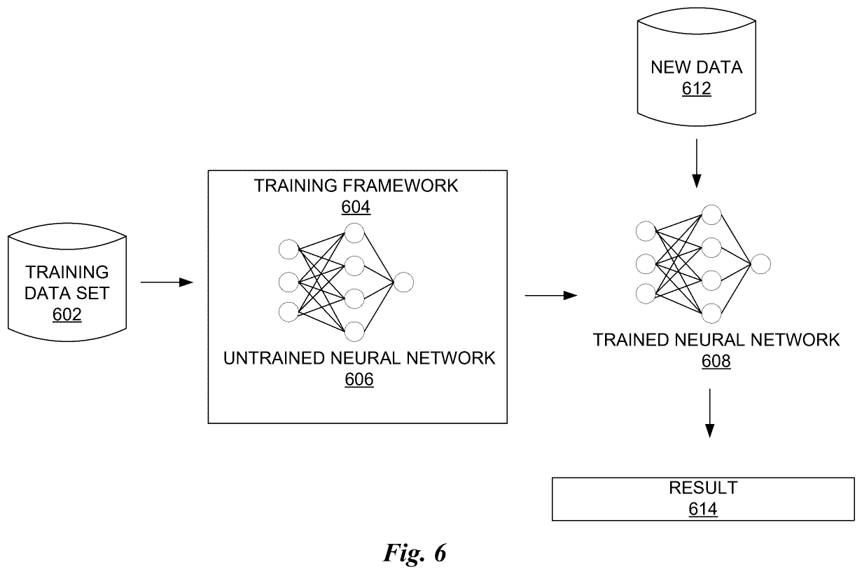

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

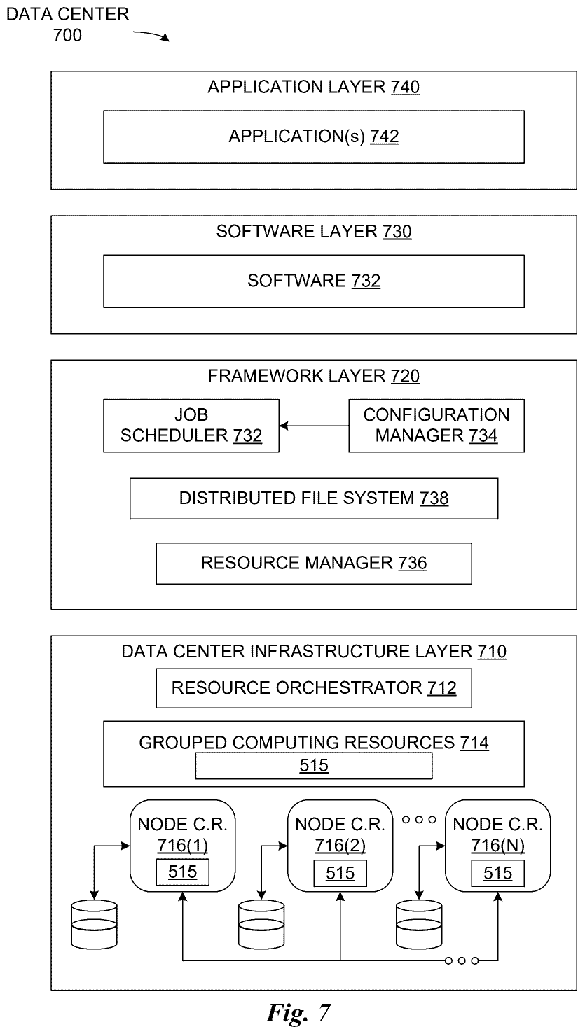

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to provide referring video object segmentation. In accordance with FIGS. 1-4, embodiments may provide one or more models usable for performing inferencing operations and for providing inferenced data. The model(s) may be stored (partially or wholly) in one or both of data storage 501 and 505 in inference and/or training logic 515 as depicted in FIGS. 5A and 5B. Training and deployment of the model(s) may be performed as depicted in FIG. 6 and described herein. Distribution of the model(s) may be performed using one or more servers in a data center 700 as depicted in FIG. 7 and described herein.

What is claimed is:

1. A method, comprising
receiving an input comprised of a video and a text prompt referring to an object in the video that is to be edited;
processing at least one frame of the video and the text prompt, using a first model, to generate location information for the target object in the video, wherein the model is trained to:
generate a frame-level bounding box in the at least one frame of the video for the object referred to by the text prompt, and
provide a video-level alignment of the frame-level bounding box with the text prompt to generate the location information for the target object in the video;
processing the location information, the at least one frame of the video, and the text prompt, by a second model, to generate an object mask for the target object in the at least one frame of the video;
determining an instruction for editing the object in the video; and
based on the instruction, editing a portion of the at least one frame of the video corresponding to the object mask.

2. The method of claim 1, wherein the location information is a proposed frame-level bounding box resulting from the video-level alignment.

3. The method of claim 1, wherein the instruction for editing the object in the video is determined from the text prompt.

4. The method of claim 1, wherein for each frame of the at least one frame, the editing is performed on the portion of the frame corresponding to the object mask generated for the frame.

5. The method of claim 4, wherein the at least one frame is a plurality of frames.

6. The method of claim 1, wherein the instruction for editing the object includes an instruction to change at least one feature of the object.

7. The method of claim 5, wherein the at least one feature of the object includes a color of the object.

8. The method of claim 5, wherein the at least one feature of the object includes a size of the object.

9. The method of claim 1, wherein the second model is an image-based foundation segmentation model.

10. The method of claim 1, wherein the editing is performed by a video editing application configured to use the object mask generated for the at least one frame of the video.

11. A method, comprising:
at a device, training a model to generate location information for a target object in a video based on a text prompt referring to the target object in the video by:
accessing a training video in a dataset of training videos each labeled with a text prompt referring to an object in the training video and per-frame bounding boxes corresponding to the object in the training video;
training the model to generate frame-level bounding boxes for the object referred to by the text prompt labeled in the training video; and
training the model to provide a video-level alignment of the frame-level bounding boxes with the text prompt labeled in the training video.

12. The method of claim 11, wherein training the model to generate the frame-level bounding boxes for the object referred to by the text prompt labeled in the training video includes iteratively:
using the model to generate from the training video a set of frame-level bounding boxes for the object referred to by the text prompt labeled in the training video,
computing a loss between the set of frame-level bounding boxes and the per-frame bounding boxes labeled in the training video, and
updating the model based on the loss.

13. The method of claim 12, wherein using the model to generate from the training video the set of frame-level bounding boxes for the object referred to by the text prompt labeled in the training video includes:
extracting frame-level visual features for each frame of the training video and linguistic features of the text prompt labeled in the training video,
obtaining a set of object queries using the frame-level visual features of each frame of the training video and the linguistic features of the text prompt labeled in the training video,
using the set of object queries to generate the frame-level bounding boxes for the object referred to by the text prompt labeled in the training video,
computing a loss between the frame-level bounding boxes and the per-frame bounding boxes labeled in the training video, and
updating the model based on the loss.

14. The method of claim 13, wherein each object query in the set of object queries corresponds to a frame of the training video and includes the visual features of the frame as a key and the linguistic features of the text prompt labeled in the training video as a value.

15. The method of claim 13, wherein each object query in the set of object queries corresponds to a frame of the training video and is used to generate a plurality of candidate bounding boxes in the frame for the object referred to by the text prompt labeled in the training video, and wherein one of the candidate bounding boxes having a highest confidence score from among the plurality of candidate bounding boxes is selected as the frame-level bounding box for the frame.

16. The method of claim 11, wherein contrastive learning is used to train the model to generate the frame-level bounding boxes for the object referred to by the text prompt labeled in the training video.

17. The method of claim 16, wherein the contrastive learning is performed using a different set of frame-level bounding boxes generated by the model for a different object referred to by a different text prompt.

18. The method of claim 11, wherein training the model to provide the video-level alignment of the frame-level bounding boxes with the text prompt labeled in the training video includes:
extracting video-level visual features for the training video, and
using the video-level visual features to train the model to provide the video-level alignment of the frame-level bounding boxes with the text prompt labeled in the training video.

19. The method of claim 18, wherein the video-level visual features for the training video are extracted by:
extracting frame-level visual features for each frame of the training video,
performing cross-attention at each frame of the training video by taking the frame-level bounding box for the frame as a query and the frame-level visual features for the frame as keys and values, and
applying an average pooling operation for temporal aggregation of a result of the performance of the cross-attention at each frame of the training video to generate the video-level visual features for the training video.

20. The method of claim 18, wherein contrastive learning is used train the model to provide the video-level alignment of the frame-level bounding boxes with the text prompt labeled in the training video.

21. The method of claim 20, wherein the contrastive learning is performed using linguistic features of the text prompt labeled in the training video and linguistic features of a different text prompt referring to a different object in the training video.

22. The method of claim 11, wherein the location information for the target object is configured to be provided as a prompt to an image-based foundation segmentation model to provide referring video object segmentation for the video.

23. The method of claim 11, further comprising, at the device:
deploying the trained model.

24. The method of claim 23, wherein the trained model is deployed with an image-based foundation segmentation model to adapt the image-based foundation segmentation model to provide referring video object segmentation.

25. The method of claim 24, wherein at inference time:
the trained model generates location information for the target object in the video based on the text prompt referring to the target object in the video,
the trained model inputs the location information, the video, and the text prompt to the image-based foundation segmentation model to cause the image-based foundation segmentation model to generate object masks for the target object in the video.

26. The method of claim 25, wherein the object masks are used by a downstream application.

27. The method of claim 26, wherein the downstream application is a video editing application.

28. The method of claim 26, wherein the downstream application is a video analysis application.

29. A system, comprising:
a non-transitory memory storage comprising instructions; and
one or more processors in communication with the memory, wherein the one or more processors execute the instructions to train a model to generate location information for a target object in a video based on a text prompt referring to the target object in the video by:
accessing a training video in a dataset of training videos each labeled with a text prompt referring to an object in the training video and per-frame bounding boxes corresponding to the object in the training video;
training the model to generate frame-level bounding boxes for the object referred to by the text prompt labeled in the training video; and
training the model to provide a video-level alignment of the frame-level bounding boxes with the text prompt labeled in the training video.

30. The system of claim 29, wherein the one or more processors further execute the instructions to:
deploy the trained model.

31. The system of claim 30, wherein the trained model is deployed with an image-based foundation segmentation model to adapt the image-based foundation segmentation model to provide referring video object segmentation.

32. The system of claim 31, wherein at inference time:
the trained model generates location information for the target object in the video based on the text prompt referring to the target object in the video,
the trained model inputs the location information, the video, and the text prompt to the image-based foundation segmentation model to cause the image-based foundation segmentation model to generate object masks for the target object in the video.

33. The system of claim 32, wherein the object masks are used by a downstream application.

34. The system of claim 33, wherein the downstream application is one of:
a video editing application, or
a video analysis application.

35. A non-transitory computer-readable media storing computer instructions which when executed by one or more processors of a device cause the device to train a model to generate location information for a target object in a video based on a text prompt referring to the target object in the video by:
accessing a training video in a dataset of training videos each labeled with a text prompt referring to an object in the training video and per-frame bounding boxes corresponding to the object in the training video;
training the model to generate frame-level bounding boxes for the object referred to by the text prompt labeled in the training video; and
training the model to provide a video-level alignment of the frame-level bounding boxes with the text prompt labeled in the training video.

36. The non-transitory computer readable medium of claim 35, wherein the one or more processors further cause the device to:
deploy the trained model.

37. The non-transitory computer readable medium of claim 36, wherein the trained model is deployed with an image-based foundation segmentation model to adapt the image-based foundation segmentation model to provide referring video object segmentation.

38. The non-transitory computer readable medium of claim 37, wherein at inference time:
the trained model generates location information for the target object in the video based on the text prompt referring to the target object in the video,
the trained model inputs the location information, the video, and the text prompt to the image-based foundation segmentation model to cause the image-based foundation segmentation model to generate object masks for the target object in the video.

39. The non-transitory computer readable medium of claim 38, wherein the object masks are used by a downstream application.

40. The non-transitory computer readable medium of claim 39, wherein the downstream application is one of:
a video editing application, or
a video analysis application.
